(19) United States
(12) Patent Application Publication
(10) Pub. No.: US 2014/0087176 A1
(43) Pub. Date: Mar. 27, 2014

(54) ARTICLES COMPRISING A WEATHER-RESISTANT ADHESIVE LAYER IN CONTACT WITH A LOW SURFACE-ENERGY MATERIAL

(71) Applicant: E I DU PONT DE NEMOURS AND COMPANY, Wilmington (DE)

(72) Inventor: CHEN QIAN ZHAO, Newark, DE (US)

(21) Appl. No.: 13/930,399

(22) Filed: Jun. 28, 2013

Related U.S. Application Data
(60) Provisional application No. 61/665,941, filed on Sep. 25, 2012.

(51) Int. Cl. B32B 27/08; B32B 27/06; C09J 7/02; B32B 27/32

(52) U.S. Cl. CPC B32B 27/08; B32B 27/322; B32B 27/065; C09J 7/02
USPC 428/317.7; 428/421; 428/422; 428/221

(57) ABSTRACT

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes an organopolysiloxane composition and a platinum catalyst. The organopolysiloxane composition includes a first polysiloxane comprising H end groups and a second polysiloxane comprising alkyl end groups, alkenyl end groups or a mixture thereof.

### FIELD OF THE INVENTION

This invention relates to laminate articles comprising an adhesive layer, containing an organopolysiloxane composition and a platinum catalyst, that is weather-resistant and has good adhesion to low surface energy materials.

### BACKGROUND

Fluorine-containing materials such as polytetrafluoroethylene, polyvinylidene fluoride (PVDF), and terpolymers of tetrafluoroethylene, hexafluoropropylene and vinylidene fluoride have excellent chemical and physical inertness, as well as excellent barrier properties and hydrophobic characteristics. As a result, such materials have excellent weatherability and high thermal stability. However, fluorine-containing materials are expensive and it would often be desirable to use them in combination with other materials, e.g., in laminates, to reduce costs. But fluorine-containing materials inherently have low surface energy and suffer from poor adhesion to dissimilar materials, making it difficult to form laminates. To overcome this problem, various methods for improving the adhesion properties of fluorine-containing materials have been investigated.

One approach is to modify the fluorine-containing material itself to enable its adhesion to an existing hydrocarbon material (e.g., an adhesive) via a wet or dry surface treatment of the fluorine-containing material. Alternatively, the fluoropolymer can be modified, for example, by creating a polymer blend or by dehydrofluorination.

Other efforts have focussed on developing adhesives that adhere well to fluorine-containing materials. U.S. Pat. No. 5,079,047 proposes a solventless, photoinitiated adhesive comprising, by weight, 60-95% of an alkyl acrylate, 5-40% of a copolymerizable monomer such as acrylic acid, and 10-30% ethylene vinyl acetate. U.S. Pat. No. 3,737,483 proposes a carboxylated polymer product comprising maleic anhydride polymerized with an alpha-olefin in contact with an ethylene vinyl acetate (EVA) copolymer in the presence of an organic peroxide and organic diluent. U.S. Pat. No. 3,749,756 proposes the same carboxylated polymer product without the peroxide and organic diluent. U.S. Pat. No. 4,347,341 proposes ethylene graft copolymers containing anhydride or carboxyl groups which are made from vinyl esters of monocarboxylic acid, maleic anhydride and esters thereof which are radically polymerized in the presence of 30-95% by weight of ethylene homopolymers or ethylene vinyl ester copolymers. U.S. Pat. No. 4,762,882 proposes modified polyolefin resins which consist essentially of a copolymer of ethylene and alpha-olefin and an unsaturated carboxylic acid grafted on the ethylene copolymer. U.S. Pat. No. 4,810,755 proposes an adhesive composition comprising a metal-containing composition consisting of an ethylene-(meth)acrylate copolymer grafted with an ethylenic unsaturated carboxylic acid or its acid anhydride and an ethylenic unsaturated carboxylic or its acid anhydride of a metal hydroxide. U.S. Pat. No. 4,908,411 proposes modified ethylenic random copolymers derived from ethylene alpha-olefin copolymers grafted with unsaturated carboxylic acids, styrene-type hydrocarbons, or unsaturated silanes. U.S. Pat. No. 4,917,734 proposes ethylene copolymers which have been grafted with styrene-based, vinyl, acrylic, and/or methacrylic grafting monomers. U.S. Pat. No. 4,977,212 proposes resin compositions comprising a metal-containing composition consisting of an ethylene ester copolymer and an unsaturated carboxylic acid or its acid anhydride, a saponified EVA copolymer, and a hydrophobic thermoplastic resin.

U.S. Pat. No. 6,441,114 discloses the use of amide-containing adhesives with substrates derived from hydrofluorinated monomers.

U.S. Pat. No. 7,767,752 discloses acrylic pressure-sensitive adhesives comprising an acrylic polymer, an ester plasticizer, an alkali metal salt, and a multifunctional cross-linking agent such as an isocyanate, epoxy, aziridine or metal chelate cross-linking agent.

Despite such proposals, there is still a need for adhesives that possess enhanced adhesion to low surface energy substrates such as fluorine-containing polymer substrates. There is also a need for laminated articles comprising fluorine-containing polymer substrates that are weather-resistant.

### SUMMARY

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes an organopolysiloxane composition and a platinum catalyst. The organopolysiloxane composition includes a first polysiloxane comprising H end groups and a second polysiloxane comprising alkyl end groups, alkenyl end groups or a mixture thereof.

### BRIEF DESCRIPTION OF THE FIGURE

FIG. 1 depicts a multilayer structure comprising an FEP layer 1, an adhesive layer 2 comprising an organopolysiloxane composition and a platinum catalyst, and a PET layer 4 coated on both sides with an atomic layer deposition coating of alumina 3.

### DETAILED DESCRIPTION

One aspect of the invention is a laminate article comprising:

a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:
i) an organopolysiloxane composition comprising a first polysiloxane comprising H end groups and a second polysiloxane comprising alkyl end groups, alkenyl end groups or a mixture thereof; and
ii) a platinum catalyst.

Suitable first substrate layers include fluoropolymer films, fluoropolymer sheets and fluoropolymer-coated substrates. Suitable fluoropolymers include polytetrafluoroethylene (PTFE), polyvinyl fluoride (PVF), polyvinylidene fluoride (PVDF), fluorinated ethylene-propylene (FEP) copolymer, and polyethylenetetrafluoroethylene (ETFE).

Suitable second substrate layers include foamed sheets, metal sheets, fabric, and polymer films and sheets. Suitable polymer films and sheets include those comprising polyolefins (e.g., polyethylene and polypropylene), polyamides (e.g., nylon-6, nylon-6,6, and nylon-6,12) polyimides and polyesters (e.g., polyethylene terephthalate, polyethylene naphthalate, and polytrimethylene terephthalate). The polymer films and sheets may be coated, for example with metals (e.g., aluminum), metal oxides (e.g., aluminum oxide, or indium tin oxide), or metal nitrides (e.g., silicon nitride).

The adhesive layer can be applied to either the first or second substrate layers, or both the first and second substrate layers, but typically is applied to the more robust of the two substrate layers. The adhesive layer, which comprises a mixture of an organopolysiloxane composition and a platinum catalyst, can be applied to one or both sides of the substrate in a conventional manner, for example, by spraying, knife-coating, roller-coating, casting, drum-coating, or dipping. Indirect application using a transfer process with silicon release paper also can be used.

The adhesive layer can have any useful thickness. In some embodiments, the adhesive layer has a thickness of 25-75 micrometers, or 25-50 micrometers.

After the adhesive layer has been applied to the first and/or second substrate layer, the coated substrate layer can be dried at a temperature from 75-150° C. to remove solvent or other volatile materials.

The article can be formed by conventional laminate-forming techniques. For example, a first substrate layer comprising a fluorine-containing surface can be coated with a mixture comprising the polydimethylsiloxane adhesive and the platinum catalyst, followed by drying. Then the second substrate layer can be placed in contact with the dried adhesive composition to form the laminate.

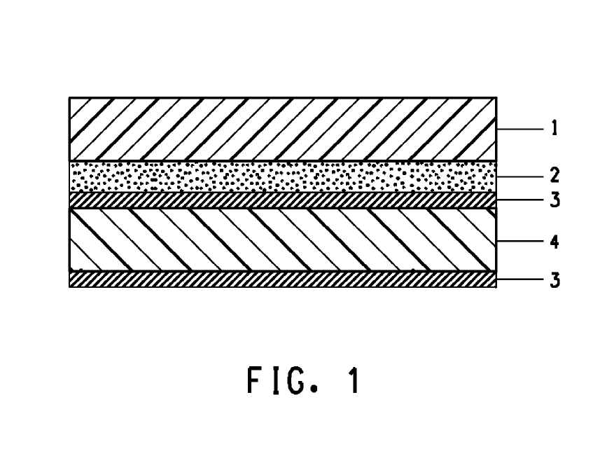

In one embodiment, as depicted in FIG. 1, a multilayer structure can comprise a fluorinated ethylene-propylene (FEP) copolymer layer 1, an adhesive layer 2 comprising an organopolysiloxane composition and a platinum catalyst, and a polyethylene terephthalate (PET) layer 4 coated on both sides with an atomic layer deposition (ALD) coating of alumina 3.

Organopolysiloxanes are polymeric organosilicon compounds with a nominal chemical formula of R[Si(CH₃)₂O]ₙSi(R)₃, where n can be from about 500 to about 100,000, and R can either be hydrogen or can be selected from the group consisting of C₁-C₁₀ alkyl or C₂-C₁₀ alkenyl. In some embodiments, the organopolysiloxanes of the present invention can comprise organopolysiloxanes wherein R can independently be alkyl and/or alkenyl. The organopolysiloxanes can also have branch points within an otherwise linear chain structure.

Organopolysiloxanes are commercially available and can be, for example, thin pourable liquids having low viscosity or thick rubbery semi-solids of high viscosity. The viscosity can be related, in part, to the molecular weight, wherein a higher molecular weight results in a higher viscosity.

The organopolysiloxane adhesive composition of the present invention is a mixture comprising: a) a first organopolysiloxane wherein R is H; and b) a second organopolysiloxane wherein R is alkenyl or alkyl. Organopolysiloxane adhesives of the present invention can alternatively be referred to herein as “polysiloxane adhesives” or “polysiloxanes”. It is understood that the adhesive of the present invention comprises the first and second organopolysiloxane, in addition to other components, as described herein. Reference to the organopolysiloxane as a component of the adhesive rather than as the adhesive composition should be clear from the context of the term.

Suitable first organopolysiloxanes comprising groups having silicon-hydrogen bonds include organohydrogenpolysiloxanes having an average of at least two silicon-bonded hydrogen atoms per molecule and an average of no more than one silicon-bonded hydrogen atom per silicon atom. The groups comprising silicon-bonded hydrogen atoms can be located at terminal or pendant positions. When at terminal positions, these groups can be referred to herein as “H-end groups”. Suitable polysiloxanes with H-end groups include methyl hydrogen dimethylsiloxane copolymer.

Suitable second organopolysiloxanes comprise terminal alkyl groups, also referred to herein as “alkyl end groups”, alkenyl groups, also referred to herein as “alkenyl end groups” and mixtures thereof. Alkenyl groups include polydiorganosiloxanes containing an average of at least two silicon-bonded alkenyl groups per molecule. Suitable alkenyl groups can comprise from 2 to about 10 carbon atoms, such as for example: vinyl, allyl, butenyl, and hexenyl groups. Alkenyl groups can be located at terminal and/or pendant positions. Suitable alkyl groups are independently selected from monovalent hydrocarbon and monovalent halogenated hydrocarbon groups free of aliphatic unsaturation. These monovalent groups can comprise from 1 to about 20 carbon atoms, and are exemplified by methyl, ethyl, propyl, butyl, pentyl, octyl, undecyl, cyclohexyl, 3,3,3-trifluorpropyl, 3-chloropropyl, dichlorophenyl, phenyl, tolyl, xylyl and benzyl groups. Alkyl groups can be located at terminal and/or pendant positions. The second organopolysiloxane can comprise both alkenyl and alkyl end groups. Suitable polysiloxanes comprising vinyl end groups include dimethylvinyl-terminated dimethylpolysiloxane-silicate copolymers.

Suitable commercially available organopolysiloxanes include Dow Corning® 7358 (“DC7358,” polydimethylsiloxane resin), and Dow Corning® Q2-7735 (“DCQ@7735,” polydimethylsiloxane resin), both from Dow Corning Co., Midland, Mich.

Organopolysiloxanes can also be readily prepared from chloro- or acetoxysilanes. Polydimethylsiloxanes can be synthesized from dimethyldichlorosilane or diacetoxydimethylsilane and water. Silane precursors such as methyltrichlorosilane can be used to introduce branches or cross-links in the polymer chain.

Suitable platinum catalysts for use in this invention include platinum salts (e.g., chloroplatinic acid, H₂PtCl₆) and organometallic platinum compounds such as PtCl₂ (cyclooctadiene), Karstedt catalyst (a compound of platinum(0) and divinyltetramethyldisiloxane), diethylenyl tetramethyldisiloxane platinum complex, and Dow Corning Syl-Off 4000, an organo-platinum complex dispersed in polysiloxane (Dow Corning Co., Midland, Mich.).

The adhesive layer optionally comprises from about 25-75 wt % of an organic solvent in which the other components of the adhesive layer can be dissolved. Suitable solvents include alcohols (ethanol, propanol, isopropanol, butanol, methyl cellusolve, butyl cellusolve, and 4-hydroxy-4-methyl-2-pentanone); esters solvents such as ethyl acetate and butyl acetate; ketone solvents such as methyl ethyl ketone and cyclohexanone; and hydrocarbon solvents such as hexane, cyclohexane, heptane, benzene, xylene, and toluene.

The adhesive layer can also be tackified. Hydrogenated hydrocarbon resins are especially useful when long-term resistance to oxidation and ultraviolet light exposure is required. Suitable hydrogenated resins include: the Escorez 5000 series of hydrogenated cycloaliphatic resins from Exxon; hydrogenated C₉ and/or C₅ resins such as the Arkon® P series of resins by Arakawa Chemical; hydrogenated aromatic hydrocarbon resins such as Regalrez 1018, 1085 and the Regalite® R series of resins from Hercules Specialty Chemicals. Other useful resins include hydrogenated polyterpenes such as Clearon® P-105, P-115 and P-125 from the Yasuhara Yushi Kogyo Company of Japan.

In some embodiments, the adhesive layer also comprises additives such as wetting agents, pigments, antioxidants, ultraviolet absorbers, antistatic agents, lubricants, fillers, opacifying agents, anti-foam agents, reactive diluents (e.g., 1-tetradecene) and heat- and light-stabilizers (e.g., hindered amines). When present, the additives comprise in total less than 10 wt % of the adhesive layer.

In some embodiments, the adhesive has an inherent viscosity in a range of 0.3 dl/g or greater, or from 0.3-2.0 dl/g, or from 0.7-2.0 dl/g. In some embodiments, the adhesive has a glass transition temperature of −10° C. or less, or from −70 to −20° C., and a 180° peel adhesion test value in a range of 5-40 oz/in, or 7-25 oz/in, or 10-20 oz/in. In some embodiments, the adhesive layer has a 30 minute gap test value of 3 mm or less, or 2 mm or less, and a haze test value of less than 10%, or less than 5%, or less than 2%. In some embodiments, the adhesive layer is colorless as defined by the CIELAB color scale, with an L* value of 95 or more, and a* and b* values between −0.7 and +0.7.

In some embodiments, the molecular weight of the adhesive is 800,000-2,000,000. Although there are many factors that contribute to the properties of an adhesive, it is generally believed that tack and resistance to peel increase with increasing molecular weight until a maximum is reached. If the molecular weight is increased by too much, there can be a deterioration of desired properties because adhesives that contain higher molecular weight polymers tend to have more cohesive strength, but lower adhesive strength. For the present adhesive polymers this maximum is reached at a relatively low molecular weight, but may not be a discrete molecular weight maximum. One of ordinary skill can determine the limitations of molecular weight versus properties for the adhesives of the present invention.

In some embodiments, the adhesive layer comprises: an adhesive with an inherent viscosity in a range of 0.7-2.0 dl/g; 0.1-60 ppm of a platinum catalyst; and 15 to 50 parts of a tackifier compatible with the adhesive.

In other embodiments, the adhesive layer comprises 100 parts of an adhesive having an inherent viscosity in a range of 0.3 to 0.7 dl/g; 0.2 to 50 ppm of a platinum catalyst; and 5 to 40 parts of a tackifier compatible with the adhesive.

In further embodiments, the adhesive layer comprises 100 parts of an adhesive having an inherent viscosity in a range of 1.5 to 2.0 dl/g; 0.2 to 20 ppm of a platinum catalyst; and 20 to 50 parts of a tackifier compatible with the adhesive.

In another embodiment, the adhesive layer comprises 100 parts of an adhesive having an inherent viscosity in a range of 0.5 to 1.0 dl/g; 0.4 to 10 ppm of a platinum catalyst; and 10 to 35 parts of a tackifier compatible with the adhesive.

### EXAMPLES

### General

The following materials are referred to in the Examples, and are identified here.

Dow Corning® 2013, solvent-free, polydimethylsiloxane resin (Dow Corning, Midland, Mich.).

Dow Corning® 7657, polydimethylsiloxane resin (Dow Corning, Midland, Mich.).

Dow Corning Syl-Off 4000, an organo-platinum complex dispersed in polysiloxane (Dow Corning Co., Midland, Mich.).

### Examples 1-2

The adhesive formulations were prepared by mixing the polymers, additives, and solvent, in the ratios listed in Table 1.

TABLE 1

| | Resin | Organo-platinum complex | Solvent |
|---|---|---|---|
| Example | (parts by wt) | (parts by wt) | (parts by wt) |
| 1 | Dow Corning ® | Dow Corning Syl-Off 4000 | Toluene |
| | 2013 (10) | (0.02) | (1.5) |
| 2 | Dow Corning ® | Dow Corning Syl-Off 4000 | Toluene |
| | 7657 (10) | (0.04) | (1.5) |

The formulated adhesives were applied to fluorinated ethylene propylene (FEP) copolymer film by manual drawdown using a No. 4 Meyer rod, and then dried at 105° C. for 1 min. Dry coating thickness was 0.8-1.0 mil. A sample of ALDPET (PET film coated with aluminum oxide via atomic layer deposition) film was laminated using a Pressure Sensitive Tape Council roller at room temperature to the adhesive-coated FEP film.

The peel strength between the ALDPET and FEP layers of the as-made laminate was measured on an Instron® Universal Testing Instrument Model 1122 (Instron Worldwide, Norwood, Mass.), using 1″ strips cut from the laminated samples. The peel strength was measured using a 50 Kg loading in a 90° peel test. The free ends of ALDPET and FEP layers of the laminated sample were put into the clamps of the Instron tester and pulled in opposite directions (at an angle of 90° from the sample) at a rate of 12 inches/min. Usually a large initial tension force is required to start the peel, and a constant steady-state force is needed to propagate the peel. Testing was stopped after the clamps had moved 3″ from each other relative to their starting position. This geometry is based on ASTM D903, a standard test method for Peel or Stripping Strength of Adhesive Bonds. Results of this test for Examples 1-2 are shown in Table 2.

A multi-layer lamination sample was made by laminating a second adhesive-coated FEP film to the unlaminated side of the ALDPET layer of the ALDPET/FEP laminate to make an FEP/ALDPET/FEP laminate.

Samples of an FEP/ALDPET/FEP laminate were subjected to the humidity simulation test at 85% humidity and 85° C. for up to 2000 hours. The laminates did not undergo significant degradation. The peel strength between ALDPET and FEP layers after heat and humidity exposure are shown in Table 2 for Examples 1-2.

TABLE 2

| | | After heat and |
|---|---|---|
| Example | As-made laminates | humidity testing |
| 1 | 544 | 1410 |
| 2 | 1156 | 1534 |

A 7.5 cm×7.5 cm lamination sample was tested in the UV exposure simulation test for 1200 hours, during which time the laminate did not undergo significant degradation. In this test, an Atlas Weather-Ometer® Model Ci 65 (Atlas Electric Devices Company, Chicago, Ill.), was used, which utilized a water-cooled xenon arc lamp set at 0.55 watts/m², a borosilicate outer filter, and a quartz inner filter to provide a constant source of 340 nm light. The peel strength results between the ALDPET and PET layers after UV exposure for Examples 1-2 are given in Table 3. The environmental temperature of the UV chamber was 67° C.

TABLE 3

| Example | As-made laminates | After UV exposure |
|---|---|---|
| 1 | 544 | 1060 |
| 2 | 1156 | 1060 |

The optical properties of the films were determined by Total Luminous Transmission (TLT), measured on an XL 211 Hazeguard™ or Hazeguard™ Plus system, available from BYK Gardner of Columbia, Md. using ASTM method D1003-92. Higher TLT values correspond to less reflection and glare, with a value above 94 being considered the minimum acceptable for good anti-reflective performance. The Total Luminous Transmission (TLT) before and after 2500 hours of 85° C. and 85% humidity test are given in Table 4.

TABLE 4

| Example | As-made laminates | Initial TLT | TLT after 2500 h |
|---|---|---|---|
| 1 | 544 | 95.5 | 95.3 |
| 2 | 1156 | 95.3 | 95.2 |

What is claimed is:

1. A laminate article comprising:
a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:
i) an organopolysiloxane composition comprising a first polysiloxane comprising H end groups and a second polysiloxane comprising alkyl end groups, alkenyl end groups or a mixture thereof; and
ii) a platinum catalyst.

2. The laminate article of claim 1, wherein the first substrate layer comprises fluoropolymer films, fluoropolymer sheets or fluoropolymer-coated substrates.

3. The laminate article of claim 2, wherein the fluoropolymer is selected from the group consisting of polytetrafluoroethylene, polyvinyl fluoride, polyvinylidene fluoride, fluorinated ethylene-propylene copolymer, and polyethylenetetrafluoroethylene.

4. The laminate article of claim 1, wherein the second substrate layer comprises foamed sheets, metal sheets, fabric, polymer films or polymer sheets.

5. The laminate article of claim 4, wherein the polymer is selected from the group consisting of polyolefins, polyamides, polyimides, and polyesters.

6. The laminate article of claim 4, wherein the second substrate layer is coated with a metal, a metal oxide or a metal nitride.

7. The laminate article of claim 1, wherein the platinum catalyst is selected from the group consisting of platinum salts and organometallic platinum compounds.

8. The laminate article of claim 1, wherein the adhesive layer further comprises additives selected from the group consisting of tackifiers, solvents, wetting agents, pigments, antioxidants, ultraviolet absorbers, antistatic agents, lubricants, fillers, opacifying agents, anti-foam agents, and heat- and light-stabilizers.
